(19) United States
(12) Patent Application Publication
(10) Pub. No.: US 2015/0212206 A1
(43) Pub. Date: Jul. 30, 2015

(54) AUTOMATIC DEPENDENT SURVEILLANCE DATA PROTECTION METHOD FOR AIR TRAFFIC MANAGEMENT, AND SYSTEM FOR THE SAME

(71) Applicant: Electronics and Telecommunications Research Institute, Daejeon (KR)

(72) Inventors: Seoung Hyeon LEE, Daejeon (KR); Deok Gyu LEE, Yongin-si (KR); Byeong Cheol CHOI, Daejeon (KR); Yong Kyun KIM, Seoul (KR); Jong Wook HAN, Daejeon (KR); Hyo Dal PARK, Incheon (KR)

(73) Assignee: Electronics and Telecommunications Research Institute, Daejeon (KR)

(21) Appl. No.: 14/607,683

(22) Filed: Jan. 28, 2015

(30) Foreign Application Priority Data
Jan. 29, 2014 (KR) 10-2014-0011087

(51) Int. Cl. G01S 13/93; G08G 5/00; H04L 29/06; H04W 12/06

(52) U.S. Cl. CPC G01S 13/9303; H04W 12/06; G08G 5/0073; H04L 63/0823; H04L 63/0428

(57) ABSTRACT

Disclosed is an automatic dependent surveillance data protection method which is performed by an authentication server. The automatic dependent surveillance data protection method includes receiving an authentication request of an ADS-B receiver from at least one client, performing authentication of the ADS-B receiver in response to the authentication request, issuing a certificate of the ADS-B receiver when the authentication of the ADS-B receiver is valid, and transmitting the issued certificate of the ADS-B receiver to the client and at least one authentication information sharing client.

### CROSS-REFERENCE TO RELATED APPLICATION

This application claims priority to and the benefit of Korean Patent Application No. 10-2014-0011087, filed on Jan. 29, 2014, the disclosure of which is incorporated herein by reference in its entirety.

### BACKGROUND

1. Field of the Invention

The present invention relates to an automatic dependent surveillance data protection method for air traffic management and system for the same, and more particularly, to an automatic dependent surveillance data protection method for improving security and reliability for the next-generation air traffic control system, which may authenticate the source of automatic dependent surveillance-broadcast (ADS-B) data, encrypt the ADS-B data transmitted through a network, and decrypt the ADS-B data whose authentication is confirmed through a certificate, between an ADS-B receiver for collecting aircraft location information in the next-generation air traffic control system and the air traffic control system, and a system for the same.

2. Discussion of Related Art

Automatic dependent surveillance-broadcast (ADS-B) is a method that generates data such as location, altitude, speed, and the like of an aircraft using global positioning system (GPS) information of a satellite and transmits the generated data at both air-to-air and air-to-ground.

ADS-B is an essential technique for efficiently operating the airspace in order to prepare for the volume of air traffic which is expected to continue to increase, and can determine an accurate location, altitude, and speed of an aircraft which are fundamental in air traffic control, thereby providing assistance to reduce an aircraft separation spacing which is essential to efficiently use empty airspace while preventing collisions between aircraft, and providing great assistance to control the airspace exceeding a scanning range of, particularly, a primary radar.

However, despite being a key technology of the next-generation air traffic control system, ADS-B does not have any special protection for receiving GPS information or transmitting/receiving flight information of the aircraft to/from the outside.

For example, in a program called “All Tech Considered” by national public radio (NPR) in the United States in 2012, a large number of ghost aircraft were generated by forging ADS-B information to confuse controllers, and a testing of hijacking a unmanned surveillance vehicle by forging GPS information in a test operated by the United States Department of Homeland Security has been successfully performed by the security research group of the University of Texas.

In addition, NPR noted that they can build a software-based wireless system capable of fooling a system using fake ADS-B signals, and has actually demonstrated this.

However, in the related art, ADS-B data in the next-generation air traffic control system provides movement information of the aircraft such as the accurate location, speed, and the like based on GPS to thereby efficiently control air traffic and prevent collisions between aircraft. On the other hand, when being wrongfully used by hackers, ADS-B data may disrupt air traffic flow all over the world and when forged ADS-B data is provided to an air traffic control center, this may be a big threat to air traffic control.

### SUMMARY OF THE INVENTION

The present invention is directed to an automatic dependent surveillance data protection method that may authenticate each receiver for receiving automatic dependent surveillance-broadcast (ADS-B) data in order to protect ADS-B data transmitted between air traffic control systems from an ADS-B receiver, and encrypt in real-time the ADS-B data transmitted between the ADS-B receiver and the air traffic control system to thereby provide security and reliability of the air traffic control system, and a system for the same.

According to an aspect of the present invention, there is provided an authentication server including: a communication unit that transmits and receives data between at least one client and at least one authentication information sharing client; an authentication performing unit that performs authentication of an automatic dependent surveillance-broadcast (ADS-B) receiver in response to an authentication request of the ADS-B receiver received from the client through the communication unit; and a certificate issuance unit that issues a certificate of the ADS-B receiver when the authentication of the ADS-B receiver is valid, and transmits the issued certificate of the ADS-B receiver to the client and the authentication information sharing client through the communication unit.

According to another aspect of the present invention, there is provided an automatic dependent surveillance data protection method which is performed by an authentication server, including: receiving an authentication request of an ADS-B receiver from at least one client; performing authentication of the ADS-B receiver in response to the authentication request; issuing a certificate of the ADS-B receiver when the authentication of the ADS-B receiver is valid; and transmitting the issued certificate of the ADS-B receiver to the client and at least one authentication information sharing client.

According to still another aspect of the present invention, there is provided an authentication information sharing client, including: a communication unit that transmits and receives data between a client and an authentication server; a control unit that receives encrypted ADS-B data from the client through the communication unit, receives a certificate of an ADS-B receiver from the authentication server through the communication unit, and decrypts the received ADS-B data when it is determined that the certificate of the ADS-B receiver is valid; and a decryption unit that decrypts the received ADS-B data in accordance with a control command of the control unit.

According to yet another aspect of the present invention, there is provided an automatic dependent surveillance data protection method which is performed by a client, including: transmitting an authentication request of an ADS-B receiver to an authentication server; receiving a certificate of the ADS-B receiver from the authentication server; receiving ADS-B data from the outside; encrypting the received ADS-B data; and transmitting the encrypted ADS-B data and the received certificate of the ADS-B receiver to an authentication information sharing client.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a network configuration among an authentication server, a client, and an authentication information sharing client according to an exemplary embodiment of the present invention;

FIG. 2 is a diagram illustrating a configuration of an automatic dependent surveillance data protection system according to an exemplary embodiment of the present invention; and

FIGS. 3 and 4 are flowcharts illustrating an automatic dependent surveillance data protection method according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

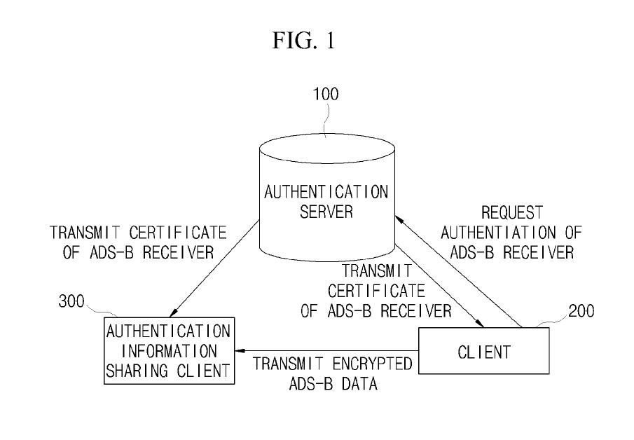

FIG. 1 is a diagram illustrating a network configuration among an authentication server, a client, and an authentication information sharing client according to an exemplary embodiment of the present invention.

As shown in FIG. 1, the network configuration includes an authentication server 100, a client 200, and an authentication information sharing client 300.

When the client 200 requests authentication of an ADS-B receiver from the authentication server 100, the authentication server 100 transmits a certificate of the ADS-B receiver to the client 200.

The client 200 transmits encrypted ADS-B data to the authentication information sharing client 300.

In addition, the authentication server 100 transmits the certificate of the ADS-B receiver to the authentication information sharing client 300.

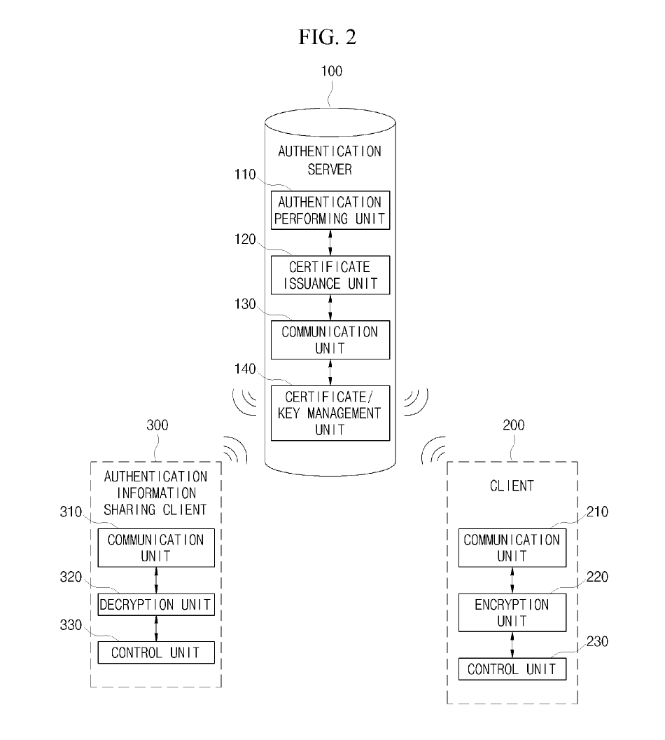

FIG. 2 is a diagram illustrating a configuration of an automatic dependent surveillance data protection system according to an exemplary embodiment of the present invention.

As shown in FIG. 2, the automatic dependent surveillance data protection system includes an authentication server 100, a client 200, and an authentication information sharing client 300.

First, the authentication server 100 will be herein described in detail.

The authentication server 100 includes an authentication performing unit 110, a certificate issuance unit 120, a communication unit 130, and a certificate/key management unit 140.

The authentication performing unit 110 performs authentication of the ADS-B receiver in response to the authentication request of the ADS-B receiver which has been received from the client 200 through the communication unit 130. Specifically, the authentication performing unit 110 determines that a certificate of the ADS-B receiver transmitted from the ADS-B receiver is valid, when the certificate of the ADS-B receiver transmitted from the ADS-B receiver is the same as a certificate registered in the authentication server 100. In addition, the authentication performing unit 110 notifies the authentication information sharing client 300, when it is determined that the certificate of the ADS-B receiver is not the same as the certificate registered in the authentication server or forged, and then displays the ADS-B receiver corresponding to this determination to be a high risk.

The certificate issuance unit 120 issues the certificate of the ADS-B receiver when the authentication of the ADS-B receiver is valid, and transmits the issued certificate of the ADS-B receiver to the client 200 and the authentication information sharing client 300 through the communication unit 130. Specifically, the certificate issuance unit 120 updates a key in each authentication request. Thus, the key is updated in each authentication request, thereby preventing the key from being forged or altered.

The certificate issuance unit 120 issues the certificate of the ADS-B receiver individually for each client 200.

The communication unit 130 transmits and receives data between at least one client and at least one authentication information sharing client.

The certificate/key management unit 140 manages the issued certificate and the updated key.

Next, the client 200 will be herein described in detail.

The client includes a communication unit 210, an encryption unit 220, and a control unit 230.

The communication unit 210 transmits and receives data between the authentication server 100 and the authentication information sharing client 300.

The encryption unit 220 encrypts ADS-B data received from the outside.

The control unit 230 transmits the authentication request of the ADS-B receiver to the authentication server 100 through the communication unit 210, receives the certificate of the ADS-B receiver, and transmits the encrypted ADS-B data and the certificate of the ADS-B receiver to the authentication information sharing client 300 through the communication unit 210.

In addition, the control unit 230 transmits the authentication request of the ADS-B receiver to the authentication server 100 at a predetermined periodic interval.

The control unit 230 determines a reception time of the ADS-B data, and discards the ADS-B data when the reception time exceeds a predetermined threshold time. Thus, it is possible to maintain real-time property the ADS-B data.

Finally, the authentication information sharing client 300 will be herein described in detail.

The authentication information sharing client 300 include a communication unit 310, a decryption unit 320, and a control unit 330.

The communication unit 310 transmits and receives data between the client 200 and the authentication server 100.

The decryption unit 320 decrypts the received ADS-B data in accordance with a control command of the control unit 330. Specifically, the decryption unit 320 decrypts the ADS-B data in real-time.

The control unit 330 receives the encrypted ADS-B data from the client 200 through the communication unit 310, and receives the certificate of the ADS-B receiver from the authentication server 100 through the communication unit 310. The control unit 330 decrypts the received ADS-B data when it is determined that the certificate of the ADS-B receiver is valid.

The control unit 330 determines a decryption time of the ADS-B data, and discards the ADS-B data when the decryption time exceeds a predetermined threshold time. Thus, it is possible to maintain real-time property the ADS-B data.

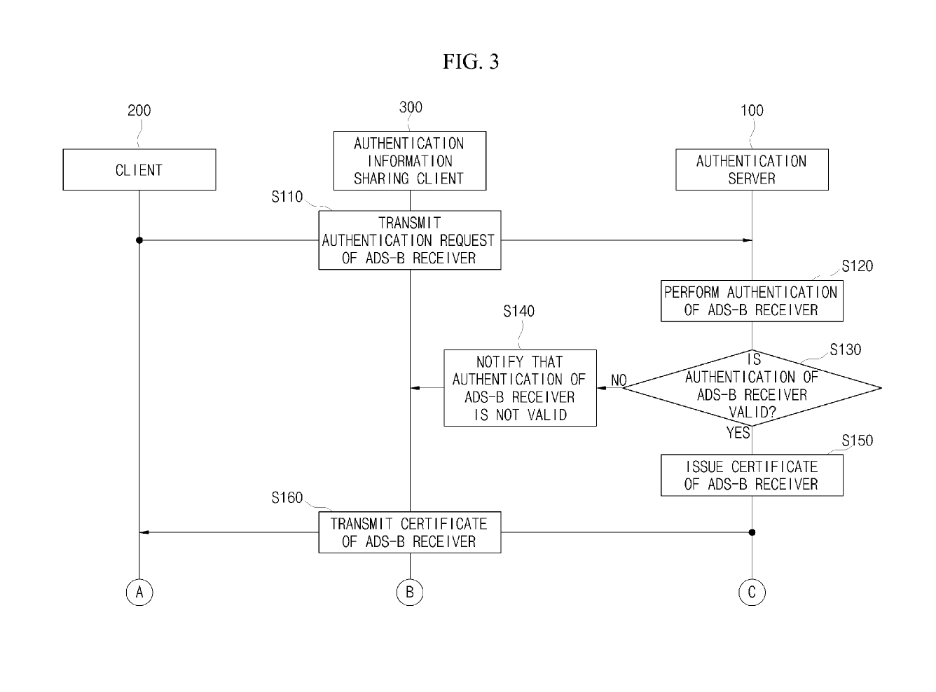

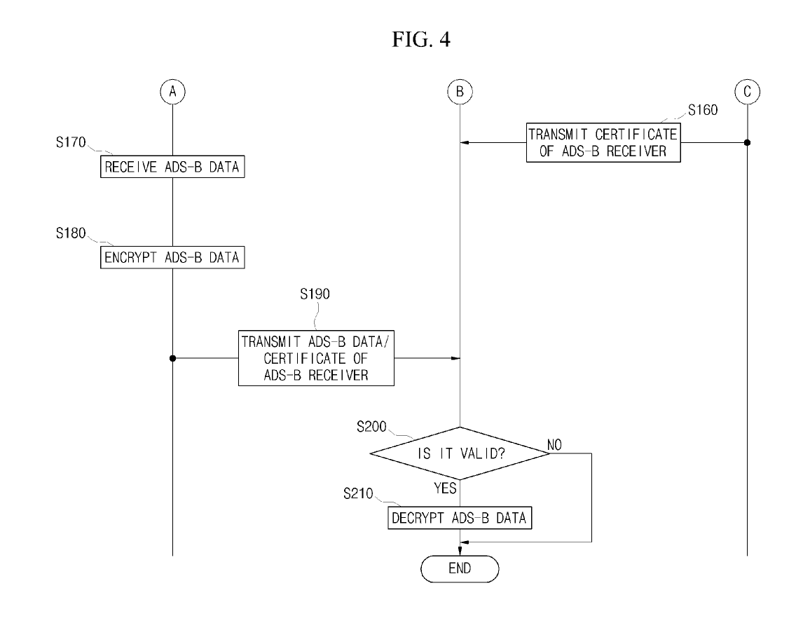

FIGS. 3 and 4 are flowcharts illustrating an automatic dependent surveillance data protection method according to an exemplary embodiment of the present invention.

As shown in FIGS. 3 and 4, first, in operation S110, the client 200 transmits an authentication request of the ADS-B receiver to the authentication server 100. Specifically, the client 200 transmits the authentication request of the ADS-B receiver to the authentication server 100 at a predetermined periodic interval.

Next, in operation S120, the authentication server 100 receives the authentication request of the ADS-B receiver from at least one client 200, and performs authentication of the ADS-B receiver in response to the authentication request.

Next, in operation S130, whether the authentication of the ADS-B receiver is valid is determined.

In operation S140, when it is determined that the certificate of the ADS-B receiver is not the same as a certificate registered in the authentication server or forged, the authentication server 100 notifies this determination to the authentication information sharing client 300. Specifically, the authentication server 100 displays the ADS-B receiver corresponding to this determination to be a high risk.

In operation S150, when the authentication of the ADS-B receiver is valid, the authentication server 100 issues the certificate of the ADS-B receiver.

Specifically, the authentication server 100 issues the certificate of the ADS-B receiver individually for each client 200.

Next, in operation S160, the authentication server 100 transmits the issued certificate of the ADS-B receiver to the client 200 and at least one authentication information sharing client 300.

Next, the authentication server 100 manages the certificate of the ADS-B receiver and a key corresponding to the certificate of the ADS-B receiver.

In addition, the authentication server 100 manages the authentication information sharing client 300.

The client 200 receives the certificate of the ADS-B receiver from the authentication server 100.

In operation S170, the client 200 receives ADS-B data from the outside. Specifically, the client 200 determines a reception time of the ADS-B data. Here, when the reception time exceeds a predetermined threshold time, the client 200 discards the received ADS-B data. Thus, it is possible to maintain real-time property the ADS-B data.

In operation S180, the client 200 encrypts the received ADS-B data.

In operation S190, the client 200 transmits the encrypted ADS-B data and the received certificate of the ADS-B receiver to the authentication information sharing client 300.

In this instance, in operation S190, the authentication information sharing client 300 receives the encrypted ADS-B data and the certificate of the ADS-B receiver from the client 200.

Next, in operation S200, the authentication information sharing client 300 determines the validity of the certificate of the ADS-B receiver. With regard to determination of the validity of the certificate of the ADS-B receiver, when the certificate of the ADS-B receiver received from the ADS-B receiver is the same as the certificate registered in the authentication server 100, the authentication information sharing client 300 determines that the certificate of the ADS-B receiver is valid.

In operation S210, when the certificate of the ADS-B receiver is valid, the authentication information sharing client 300 decrypts the received ADS-B data.

Finally, the authentication information sharing client 300 displays the decrypted ADS-B data. Thus, it is possible for a user to visually confirm the ADS-B data.

According to another embodiment of the present invention, the authentication server 100 first issues the certificate, and generates a key corresponding to the certificate when receiving the authentication request from the client 200 of the receiver.

The authentication server 100 encrypts a new key value and transmits the encrypted key value to the client 200 of the receiver.

The authentication server 100 decrypts the new key value and transmits the decrypted key value to the authentication information sharing client 300 of an air traffic control system.

The client 200 transmits the encrypted new key and ADS-B data to the authentication information sharing client 300.

The authentication information sharing client 300 decrypts the encrypted key value received from the client 200, determines whether a key value from the client 200 is the same as a key value from the authentication server 100, and determines that the ADS-B data received from the client 200 is valid when the key value from the client 200 is the same as the key value from the authentication server 100. That is, the key value rather than the certificate is transmitted, and whether the ADS-B data is valid is determined through the identicality of the key value.

According to still another embodiment of the present invention, the authentication server 100 updates and issues a new certificate whenever receiving the authentication request from the client 200.

The authentication server 100 receives the authentication request from the client 200, and issues a newly updated certificate in response to the authentication request. The authentication server 100 transmits the newly updated certificate to the client 200 and the authentication information sharing client 300. Here, the newly updated and issued certificate is used for the next authentication request. Thus, the authentication server 100 issues a new certificate whenever receiving the authentication request from the client 200, and therefore the intercepted certificate cannot be utilized even if a third party intercepts the certificate, thereby improving security.

According to yet another embodiment of the present invention, the client 200 transmits, to the authentication information sharing client 300, an identification (ID) of the receiver, an identifier, and ADS-B data which is not encrypted.

The client 200 transmits, to the authentication server 100, the authentication request, the ID and password of the receiver, and the identifier of the authentication information sharing client 300.

In addition, the client 200 transmits, to the authentication information sharing client 300, the ID and password of the receiver, the identifier of the authentication information sharing client 300, and the ADS-B data which is not encrypted.

The authentication server 100 examines whether the ID and password of the receiver are registered, and issues a certificate including a network address of the client 200, the ID of the receiver, and the identifier.

Here, the certificate is created based on the data encryption standard (DES) when issuing the certificate, and therefore it is difficult to manipulate the certificate by the client 200 or from the outside. In addition, the reason for including the network address is to prevent a third party from intercepting the certificate for use.

The authentication server 100 transmits the issued certificate to the authentication information sharing client 300.

The authentication information sharing client 300 decrypts the certificate, and confirms the ID of the receiver and the identifier which are included in the certificate based on the decrypted certificate. The authentication information sharing client 300 treats the ADS-B data as valid when the ID of the receiver and the identifier received from the client 200 are the same as the ID of the receiver and the identifier which are included in the certificate.

As described above, according to the embodiments of the present invention, in the case of transmission of virtual or forged ADS-B data to the air traffic control system, it is possible to prevent the virtual or forged ADS-B data from affecting air traffic control, thereby providing more secure air traffic control services to users.

In addition, when the encrypted ADS-B data is transmitted to the air traffic control system and authentication of the receiver is confirmed, the ADS-B data may be decrypted, thereby improving the security of the air traffic control system.

In addition, when the reception time of the ADS-B data is determined and the determined reception time of the ADS-B data exceeds the predetermined threshold time, it is possible to implement real-time property the ADS-B data by discarding the ADS-B data, thereby improving the security of the air traffic control system.

Next, the certificate of the ADS-B receiver is issued individually for each ADS-B receiver, and therefore whether the receiver is authenticated may be managed individually for each receiver, thereby improving the security of the air traffic control system.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An authentication server comprising:
a communication unit that transmits and receives data between at least one client and at least one authentication information sharing client;
an authentication performing unit that performs authentication of an automatic dependent surveillance-broadcast (ADS-B) receiver in response to an authentication request of the ADS-B receiver received from the client through the communication unit; and
a certificate issuance unit that issues a certificate of the ADS-B receiver when the authentication of the ADS-B receiver is valid, and transmits the issued certificate of the ADS-B receiver to the client and the authentication information sharing client through the communication unit.

2. The authentication server of claim 1, wherein the authentication performing unit determines, when the certificate of the ADS-B receiver transmitted from the ADS-B receiver is the same as a registered certificate, that the certificate of the ADS-B receiver is valid, and notifies, when the certificate of the ADS-B receiver is not the same as the registered certificate, this determination to the authentication information sharing client and then displays the ADS-B receiver to be a high risk.

3. The authentication server of claim 1, wherein the certificate issuance unit updates a key in each authentication request.

4. The authentication server of claim 1, wherein the certificate issuance unit issues the certificate of the ADS-B receiver individually for each client.

5. A client comprising:
a communication unit that transmits and receives data between an authentication server and an authentication information sharing client;
an encryption unit that encrypts ADS-B data received from the outside; and
a control unit that transmits an ADS-B authentication request to the authentication server through the communication unit, receives a certificate of an ADS-B receiver in response to the ADS-B authentication request, and transmits the encrypted ADS-B data and the certificate of the ADS-B receiver to the authentication information sharing client through the communication unit.

6. The client of claim 5, wherein the control unit transmits the ADS-B authentication request to the authentication server at a periodic interval.

7. The client of claim 5, wherein the control unit determines a reception time of the ADS-B data, and discards the ADS-B data when the reception time exceeds a predetermined threshold time.

8. An authentication information sharing client comprising:
a communication unit that transmits and receives data between a client and an authentication server;
a control unit that receives encrypted ADS-B data from the client through the communication unit, receives a certificate of an ADS-B receiver from the authentication server through the communication unit, and decrypts the received ADS-B data when it is determined that the certificate of the ADS-B receiver is valid; and
a decryption unit that decrypts the received ADS-B data in accordance with a control command of the control unit.

9. The authentication information sharing client of claim 8, wherein the decryption unit decrypts the ADS-B data in real-time.

10. The authentication information sharing client of claim 8, wherein the control unit determines a decryption time of the ADS-B data, and discards the ADS-B data when the decryption time exceeds a predetermined threshold time.

11. An automatic dependent surveillance data protection method which is performed by an authentication server, comprising:
receiving an authentication request of an ADS-B receiver from at least one client;
performing authentication of the ADS-B receiver in response to the authentication request;
issuing a certificate of the ADS-B receiver when the authentication of the ADS-B receiver is valid; and
transmitting the issued certificate of the ADS-B receiver to the client and at least one authentication information sharing client.

12. The automatic dependent surveillance data protection method of claim 11, wherein the performing of the authentication of the ADS-B receiver includes
determining, when the certificate of the ADS-B receiver transmitted from the ADS-B receiver is the same as a certificate registered in the authentication server, that the certificate of the ADS-B receiver is valid, and
notifying, when the certificate of the ADS-B receiver is determined to not be the same as the certificate registered in the authentication server or to be forged, this determination to the authentication information sharing client and then displaying the ADS-B receiver to be a high risk.

13. The automatic dependent surveillance data protection method of claim 11, after the transmitting of the issued certificate of the ADS-B receiver to the authentication information sharing client, further comprising:
managing the certificate of the ADS-B receiver and a key corresponding to the certificate of the ADS-B receiver; and
managing the authentication information sharing client.

14. The automatic dependent surveillance data protection method of claim 11, wherein the issuing of the certificate of the ADS-B receiver includes issuing the certificate of the ADS-B receiver individually for each client.

15. An automatic dependent surveillance data protection method which is performed by a client, comprising:
transmitting an authentication request of an ADS-B receiver to an authentication server;
receiving a certificate of the ADS-B receiver from the authentication server;
receiving ADS-B data from the outside;
encrypting the received ADS-B data; and
transmitting the encrypted ADS-B data and the received certificate of the ADS-B receiver to an authentication information sharing client.

16. The automatic dependent surveillance data protection method of claim 15, wherein the transmitting of the authentication request of the ADS-B receiver includes transmitting the authentication request of the ADS-B receiver to the authentication server at a predetermined periodic interval.

17. The automatic dependent surveillance data protection method of claim 15, wherein the receiving of the ADS-B data includes
determining a reception time of the ADS-B data, and
discarding the received ADS-B data when the reception time exceeds a predetermined threshold time.

18. An automatic dependent surveillance data protection method which is performed by an authentication information sharing client, comprising:
receiving a certificate of an ADS-B receiver from an authentication server;
receiving encrypted ADS-B data and the certificate of the ADS-B receiver from a client;
determining validity of the certificate of the ADS-B receiver; and
decrypting the received ADS-B data when the certificate of the ADS-B receiver is valid.

19. The automatic dependent surveillance data protection method of claim 18, wherein the determining of the validity includes determining that the received certificate of the ADS-B receiver is valid when the received certificate of the ADS-B receiver is the same as a certificate registered in the authentication server.

20. The automatic dependent surveillance data protection method of claim 18, after the decrypting of the ADS-B data, further comprising:
displaying the decrypted ADS-B data.
